(19) United States
(12) Patent Application Publication
(10) Pub. No.: US 2011/0025144 A1
(43) Pub. Date: Feb. 3, 2011

(54) COOLING HOUSING FOR A SWITCHED RELUCTANCE ELECTRIC DEVICE

(75) Inventors: Daniel J. Schartman, East Peoria, IL (US); Satish D. Savant, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar, Inc., Peoria, IL (US)

(21) Appl. No.: 12/510,385

(22) Filed: Jul. 28, 2009

(51) Int. Cl. H02K 9/19

(52) U.S. Cl. 310/54

(57) ABSTRACT

The present disclosure provides a fluid-cooled housing for an electric device having a housing. The housing includes an outer surface and an inner surface, the inner surface defining, at least in part, a housing cavity having a longitudinal axis, an end wall continuous with the inner surface, thereby substantially enclosing the housing cavity at a first end, and a chain of cooling channels creating a serpentine pattern defined along the inner surface of the housing.

### TECHNICAL FIELD

This disclosure relates generally to an electric device such as a motor, generator or alternator, and more specifically, to a fluid cooling arrangement for switched reluctance electric devices that includes a cooling zone in the housing unit configured for press fit assembly thereof.

### BACKGROUND

Switched Reluctance (SR) electric devices such as, for example, motors and generators, may be used to generate mechanical power in response to an electrical input or to generate electrical power in response to a mechanical input. During operation, magnetic, resistive, and mechanical losses within such motors and generators cause a build up of heat, which may be dissipated to avoid malfunction and/or failure of the device. Moreover, one of the limitations on the power output of electric generators may be the capacity of the device to dissipate this heat. Accordingly, most of these devices include some form of cooling system.

As these electric devices have become more prevalent in mobile applications, such as on work machines, a premium has been placed on smaller size and lower weight devises. These motors are more power dense and therefore more difficult to cool than their stationary counterparts. As the size decreased, air cooling alone is often insufficient to maintain temperatures of the motors at acceptable levels.

Motors and generators are often equipped with a means for cooling formed of a cooling jacket provided with grooves or passages. Circulating oil, water or even other fluid cooling means through the grooves or passages provides cooling to the motors and generators. Generally, fluid cooled generators include a rotor assembly and a stator assembly, with both assemblies disposed within a cavity defined by a housing with an inner surface. Fitted against the inner surface typically is a cooling sleeve having a series of grooves forming a cooling passage when the outer surface of the sleeve is mated against the inner surface. O-rings are positioned in the sleeve surrounding the grooves to prevent leakage of coolant. An upper axial lubricant/cooling bore typically passes through the front housing, the sleeve flange, the middle and rear housings, sealed by O-rings. Similarly, a lower lubricant/cooling sump is sealed by O-rings between the flange, front and middle housings.

The addition of a separate sleeve or other conduit forming member, along with the various sealing elements, increases both the number of parts required and production costs. The seals may be compromised, resulting in leakage of coolant into the generator cavity or into the environment. This may result in lower cooling efficiency and potential damage to the generator components.

Further, in SR motors, unlike other motors/generators, the rotor comprises a plurality of laminations stacked axially to form a laminated stack having axial ends. The rotor may include a central annular hub having a plurality of rotor poles extending radially outwardly from the hub. The laminations are typically electrically insulated from each other, and are often secured together with an adhesive material that is cured while the laminations are held together under pressure.

Interference stresses and required insertion forces are a major concern for press-fitted motors incorporating stacked laminations. Unlike other electric motors, SR motors have the added issue of conflict during insertion of the motor generator unit with laminations, into its housing. The laminations' outer diameter cause interference and potentially severe damage with the inner surface of a housing when inserted into a housing having a series of channels that are spirally disposed along the length of the housing.

Additionally, of great concern with switched reluctance devices is that during press fitting, the aforementioned SR laminations may be irreversibly damaged during the insertion where the cooling channels are primarily perpendicular to the insertion direction, under interference press fit stresses.

The present disclosure is directed to overcoming one or more of the problems set forth above.

### SUMMARY OF THE INVENTION

In one aspect, the present disclosure provides a fluid-cooled housing for an electric device having a housing. The housing includes an outer surface and an inner surface, the inner surface defining, at least in part, a housing cavity having a longitudinal axis, an end wall continuous with the inner surface, thereby substantially enclosing the housing cavity at a first end, and a chain of cooling channels creating a serpentine pattern defined along the inner surface of the housing.

These and other aspects and advantages of the present disclosure will become apparent to those skilled in the art upon reading the following detailed description in connection with the drawings and appended claims.

### BRIEF DESCRIPTION OF THE DRAWINGS

FIG. 1 is a perspective view of a housing in accordance with one embodiment of the present disclosure; and,

FIG. 2 is an exploded view of a section of the housing of FIG. 1.

### DETAILED DESCRIPTION

Reference will now be made in detail to embodiments for the present disclosure, examples of which are illustrated in the accompanying drawings. Wherever possible, the same reference numbers will be used throughout the drawings to refer to the same or like parts.

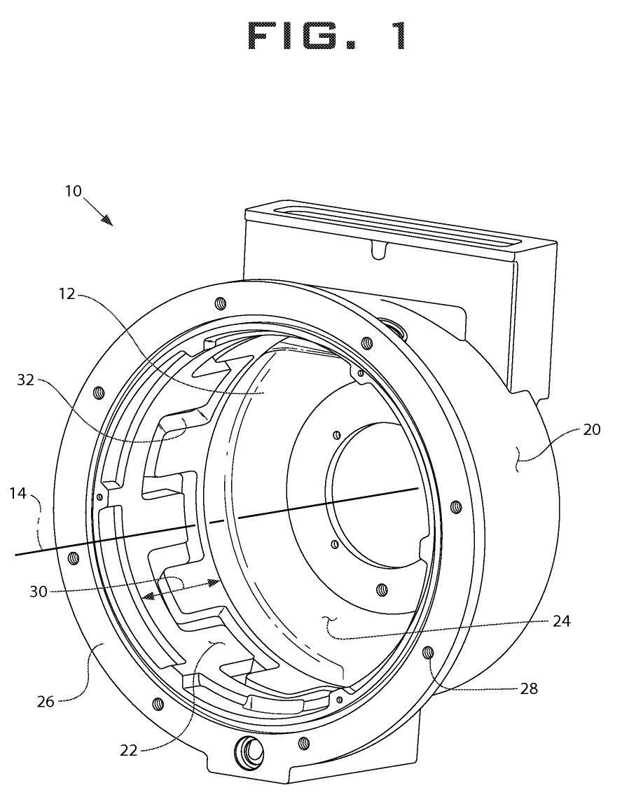

Referring to FIG. 1, shown is a perspective view of a housing 10 for a rotary electric device, such as a generator, motor or alternator, but particularly a switched reluctance electric device. Such devices are typically employed in connection with various machines to generate electric power or to convert electrical power to mechanical output. For example, such devices may be employed as a portion of a mobile machine such as, for example, a dozer, motorgrader, off-highway truck, excavator, loader or the like.

The housing 10 may be a single or multiple piece unit, consisting of for example, a front and rear housing. The housing assembly is typically home for a stator assembly (not shown), which may have a stator coil. The stator assembly is disposed within housing cavity 12 at least partially surrounding a rotor assembly (also not shown) having steel laminations; the rotor assembly being operatively connected to a power source (not shown) for rotation about axis 14, thereby generating electrical power in a conventional manner. The housing may be formed of cast or extruded steel, aluminum, copper, or other suitable metal material, including various alloys. One consideration will be selecting a material that will withstand the desired manufacturing process. In one embodiment, for example, the housing is formed via metal casting, typically of cast aluminum.

The stator may be formed of a series of thin laminates placed side-by-side, along with windings formed of conducting material. The stator may have a cylindrical shape with an inner surface and an outer surface. Each end of the stator may include end windings formed of a series of wound conductive material. A stator core and windings (not shown) are also a portion of the electric device. While the stator assembly is being primarily described as cylindrical, one skilled in the art would understand that it may be formed into many different geometrical shapes, and would compliment the shape of the housing 10.

Rotor assemblies (not shown) generally include a rotor shaft, including a pinion gear, and a steel lamination coaxial with the rotor shaft. The steel lamination may, for example, be fastened to the rotor shaft by interference fit, welding, threaded fastening, chemical bonding, or any other appropriate manner. The lamination may be positioned between a pair of opposed circular end plates, which include a series of circumferentially disposed balancing studs, employed for balancing the rotor assembly. The rotor assembly may be disposed along axis 14, supported at front end for rotational movement by a roller bearing assembly, and at rear end by a ball bearing assembly.

Turning again to FIG. 1, the housing may be generally cylindrical, having an outer surface 20 and an inner surface 22 defining inner cavity 12, which is disposed about axis 14. Enclosing one end of the housing cavity 12 is rear wall 24 that is continuous with an axial portion and inner surface 22 of the housing. “Continuous” refers to the fact that the components are unitary, formed of a single, cast piece. However, in an alternative embodiment, the rear wall 24 (or a rear portion of the housing 10) may be formed of a separate component. Extending radially from a first end 16 of the housing 10 is typically a generally annular flange 26 having a series of circumferentially disposed, spaced holes 28 for optional connection with the housing 10.

Within the housing 10 along the inner surface 22, is a cooling zone 30. Within the cooling zone 30 are cooling channels 32. The cooling channels 32 may be cast or machined into the housing 10. The cooling channels 32 may include fillet radii transitioning along the bottom surface 33 to the sidewalls 34 of the cooling channels 32 to ease the manufacture of the channels 32. Additionally, the channels may have a rectangular cross-section, elongated axially; however, a variety of other cross-sectional dimensions may be employed. For example, the channels may be cylindrical with a circular cross-section, or any other overall geometry as would be understood by one skilled in the art. However, the rectangular cross-section may be advantageous for a number of reasons. The rectangular cross-section may provide a greater surface area along the inner surface, at a constant distance from inner housing surface, which may facilitate heat exchange.

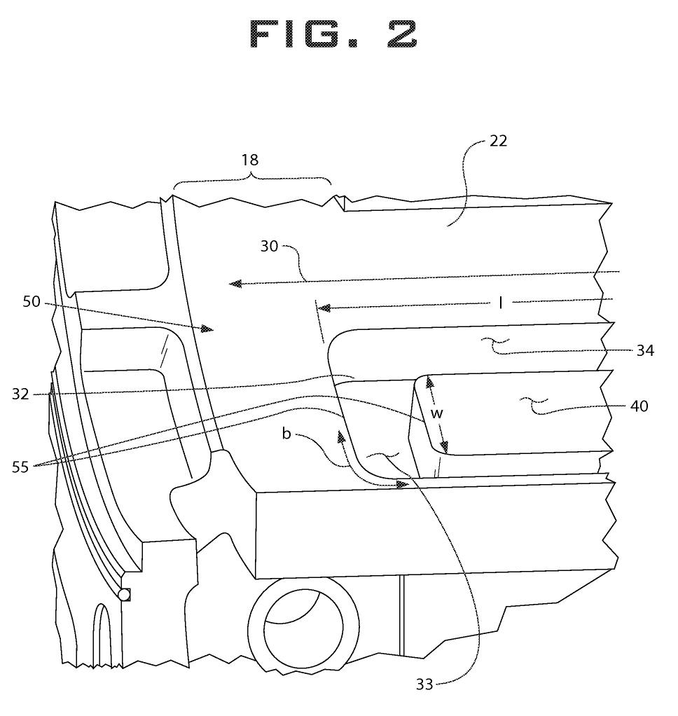

Turning now to FIG. 2, which is an exploded view of the housing of FIG. 1, the inner surface 22 defines a generally cylindric cavity for receiving a stator in heat transference contact with the inner surface 22. The cooling channels 32 create an interference surface 40, which is adjacent to and in press-fit contact with the stator assembly outer surface. The surface at the largest distance from the stator assembly outer surface is the cooling channel bottom surface 33. The cooling zone 30 of the present disclosure is located within the cylindrical housing on the inner surface 22 for receiving a rotor and stator assembly, for example, and may be formed to be in interference fit with the stator. Accordingly, the inner surface 22 (and the cooling zone 30) may be in direct contact with the outer surface of the stator.

A circumferentially defined leading edge surface 50 is located at a second opposing end 18 of the housing cavity, the leading edge surface 50 having a larger diameter than the surface immediately aft of the leading edge surface 50 for assisting non-damaging insertion of exposed laminations of a stator assembly.

The cooling channels 32 create a serpentine pattern defined along the inner surface 22 of the housing 10. Serpentine pattern is defined as an “s-shaped” back-and-forthly directed travel path. A length portion (l) of the serpentine pattern is substantially parallel to the direction of the longitudinal axis 14 of the housing 10, and a width portion (w) is substantially perpendicular to the direction of the longitudinal axis 14 or direction of travel of a stator assembly being inserted into the housing 10. The length (l) and width (w) portions may transition from one to another with curved segments or straight. The transition between length (l) and width (w) portions may be as tight as to create a “U” or “V” shape in the transitional bend (b), or as open as to create ninety (90) plus degree angles.

The serpentine pattern as defined above creates a greater ease for insertion of a stator assembly, decreasing potential damage to the stator laminations. The length and width portion lengths l, w may be uniform or varied. The length and width portions may equal each other, or may transaction along the continuous path varying along the way, or may be completely identical. The width portions (w), which lie perpendicular to the insertion direction of the stator assembly, may ideally be lessened for this very reason. Again, the cooling channel will include a number of back and forth turns, at a certain pitch, and a certain distance from end to end. However, one of skill in the art would readily appreciate that the specifications, including, without limitation, the length of the channel, depth of the channel, number of back and forth turns, distance between each channel, channel sidewall thickness, and cross-sectional dimensions may be altered to a fit a variety of applications, depending on, for example, the size, weight and cooling requirements of any specific generator.

Within the cooling zone 30, the channel leading edge 55 may be chamfered adjacent the interference surface 40, to assist with the press fit installation. In addition, the portion of the cooling channels 32 that are perpendicular to the longitudinal axis 14 and the direction of insertion of the stator assembly may also include a chamfered leading edge for ease of insertion, and to provide protection to the stator laminations upon press fitting into the housing. The leading edge immediately adjacent to the width portions (w) may be chamfered. The chamfers may be slight but prepared at an angle to minimize interference and damage to the laminations while simultaneously preventing leakage through laminations or past the weld channel (not shown).

The electric device may have an outlet port, at least one inlet port, and a vent for purging air. Cooling fluid flows through the cooling channels in one direction, but may have more than one inlet port with fluid traveling in opposing directions to the same outlet port. Yet further, there may be numerous outlet and inlet ports for cooling fluid flow. The inlet may be positioned gravitationally above the outlet, with either or both being provided with a threaded connector. In another alternative embodiment, the inlet or outlet may end in a complete turn, with tubes extending outwardly from junction boxes, and axially aligned on the same side of the generator housing.

Completely optionally, a lubricant input may be connected to a radially extending bore within a wall of the assembly. Disposed along a cooling bore may be a first t-junction, which fluidly connects to a sprayer having a nozzle that is directed to deliver lubricant at a pinion gear and wheel gear within gear cavity. Lubricant may also continue along the bore, which ends at an opening above an annular groove of a cylindrical shaft. One or more openings disposed in the groove may allow the lubricant to flow via a radial passage and axial passage to a bearing, wheel gear, inner splines, and into the gear cavity. Lubricant may also flow from the bore through a t-junction to an axial upper passage of the housing, which extends from front end to rear end thereof. At a rear end, an axial upper passage may turn into a radial rear wall passage that directs lubricant to ball bearing assembly, and along angled passage to the central rotor lubricant passage, which extends axially through the rotor shaft into the gear cavity. One or more radial passages may be fluidly connected to a central rotor passage that delivers lubricant outwardly to lubricate the various parts within the housing cavity. Lubricant that is directed into either the gear cavity or housing cavity ultimately drains through a bottom passage to the sump.

The above-described lubricant/cooling circuit may be fluidly connected to one or more lubricant pumps and a heat exchanger as known in the art, and may be part of a larger system that pumps lubricant through a variety of machine components in addition to electric device.

In operation, a cooling system may include a pump (not shown), which is fluidly connected to inlet to provide a circulating coolant, such as oil. In certain applications, water, an ethylene glycol solution, or the like may be used. The system may also include a heat exchanger to remove heat from the coolant prior to circulating the coolant back through the device. A pump may be dedicated to providing coolant for the electric device, or the system may also be fluidly connected to other components, such as an engine fluid jacket or oil heat exchanger (not shown).

While aspects of the present disclosure have been particularly shown and described with reference to the embodiments above, it will be understood by those skilled in the art that various additional embodiments may be contemplated without departing from the spirit and scope of the present disclosure as determined based upon the claims below and any equivalents thereof.

### INDUSTRIAL APPLICABILITY

The housing design of the present disclosure may be used in connection with various electric devices to provide fluid cooling with fewer components, and at a potentially lower cost than conventional designs. The fact that there are no internal seals between the coolant passages and the interior of the device may result in improved performance and lifespan of the device by preventing leakage that may occur when such seals fail. Moreover, the housings may be used in connection with switched reluctance electric devices such as, for example, motors, alternators and generators. In particular, the housing design focuses on preventing damage to stator laminations upon insertion.

Such electric devices may be used in connection with any machine that requires the generation of electrical power from a mechanical input, or mechanical power from an electrical input. This may include mobile machines such as construction, passenger and recreational vehicles, trucks, and watercraft. These devices may also be employed in mobile industrial machinery, such as that used in mining, construction, farming, transportation, or any other industry known in the art. This may include earth moving machines such as dozers, wheel loaders, excavators, dump trucks, backhoes, motorgraders and the like. In particular, the disclosed SR electric devices may find applicability in the drive systems of such vehicles. It should be recognized that a wide variety of applications, mobile and stationary, may fall within the scope of the present disclosure.

Other aspects, objects, and advantages of the present disclosure can be obtained from a study of the drawings, disclosure and the appended claims.

What is claimed is:

1. A fluid-cooled housing for an electric device, comprising:
a housing having an outer surface and an inner surface, said inner surface defining, at least in part, a housing cavity having a longitudinal axis;
an end wall continuous with said inner surface, thereby substantially enclosing said housing cavity at a first end thereof; and
a chain of cooling channels creating a serpentine pattern defined along the inner surface of said housing.

2. The housing of claim 1, wherein the cooling housing includes a second end having a radially extending circumferential flange.

3. The housing of claim 2, further comprising a cooling zone substantially centrally located along said inner surface within said housing cavity; said cooling zone housing the chain of cooling channels therein; and,
a circumferentially defined leading edge surface generally near the second end of the housing cavity, said leading edge surface having a larger diameter than the surface immediately aft of the leading edge surface for assisting non-damaging insertion of exposed laminations of a stator assembly.

4. The housing of claim 1, wherein the cooling channels have a rectangular cross-section.

5. The housing of claim 4, wherein the rectangular cross-section of the cooling channel is defined by a first, elongated dimension disposed substantially parallel to the axis.

6. The housing of claim 1, wherein the cooling channels have a circular cross-section.

7. The housing of claim 1, wherein the cooling channel is one continuous channel.

8. The housing of claim 1, wherein the cooling channel has a first end and a second end that extend outward from the outer surface of the housing.

9. The housing of claim 8, wherein the first end is positioned above the second end relative to an upper portion of the housing.

10. The housing of claim 1, wherein said cooling channel includes length portions substantially parallel to said longitudinal axis and width portions substantially perpendicular to said longitudinal axis.

11. The housing of claim 10, wherein said length and width portions alternate along said cooling channel.

12. The housing of claim 10, wherein said length and width portions and of varying dimensions.

13. The housing of claim 10, wherein said length portions are longer than said width portions.

14. The housing of claim 10, wherein said length and width portions of said serpentined patterned cooling channels resemble a continuous chain of S's.

15. A fluid-cooled electric device, comprising:
a housing including an outer surface defining, at least in part, an exterior of the electric device, and an inner surface, the inner surface defining, at least in part, a housing cavity having a longitudinal axis; and
a chain of cooling channels creating a serpentine pattern defined along the inner surface of said housing.

16. The electric device of claim 11, wherein the helical conduit has a rectangular cross-section.

17. The electric device of claim 12, wherein the rectangular cross-section is defined by a first, elongated dimension disposed substantially parallel to the axis.

18. A fluid-cooled switched reluctance electric device, comprising:
a housing including an outer surface defining, at least in part, the exterior of the generator, and an inner surface, the inner surface defining, at least in part, a housing cavity having a longitudinal axis, a chain of cooling channels creating a serpentine pattern defined along the inner surface of said housing;
a rotor having a rotor shaft operatively connected to a power source for rotation thereof, and
a stator including exposed laminations surrounding said rotor and press fitted within said housing adjacent the inner surface.

19. The electric device of claim 18, wherein leading edges of width portions of said cooling channels have chamfers.

20. The electric device of claim 18, wherein the housing cavity is substantially cylindrical, the housing further comprising a first end having a radially disposed end wall continuous with the inner surface and substantially enclosing the housing cavity at the first end.
